(19) United States
(12) Patent Application Publication
(10) Pub. No.: US 2026/0201074 A1
(43) Pub. Date: Jul. 16, 2026

(54) METHOD FOR PREPARING HOLOCELLULOSE

(71) Applicant: Peiyao WEN, Xi'an City (CN)

(72) Inventor: Peiyao WEN, Xi'an City (CN)

(21) Appl. No.: 19/193,073

(22) Filed: Apr. 29, 2025

(30) Foreign Application Priority Data
Jan. 15, 2025 (CN) 202510066354.4

(51) Int. Cl. C08B 15/08; C08H 8/00

(52) U.S. Cl. CPC C08B 15/08; C08H 8/00

(57) ABSTRACT

Provided is a method for preparing holocellulose. The method includes: mixing a biomass material and a pretreatment solution, and subjecting a resulting mixture to pretreatment and solid-liquid separation in sequence to obtain the holocellulose, where a mass percentage content of lignin in the holocellulose is lower than 6%; the pretreatment solution includes an aqueous hydrogen peroxide solution and a catalyst; the pretreatment is conducted at a pH of 2 to 7; and the catalyst includes one or more selected from the group consisting of tungstic acid, molybdic acid, tungsten carbide, molybdenum carbide, tungsten sulfide, molybdenum sulfide, heteropoly acid, and a heteropoly acid salt, where the heteropoly acid includes one or more selected from the group consisting of phosphotungstic acid and phosphomolybdic acid, and the heteropoly acid salt includes a phosphotungstate salt.

### CROSS REFERENCE TO RELATED APPLICATION

This patent application claims the benefit and priority of Chinese Patent Application No. 2025100663544 filed with the China National Intellectual Property Administration on Jan. 15, 2025, and entitled with “METHOD FOR PREPARING HOLOCELLULOSE”, the disclosure of which is incorporated by reference herein in its entirety as part of the present application.

### TECHNICAL FIELD

The present disclosure belongs to the field of treatment techniques for biomass materials, and specifically relates to a method for preparing holocellulose.

### BACKGROUND

Holocellulose refers to the residue after extracts and lignin were removed from a plant fiber material for papermaking (that is, holocellulose is the sum of hemicellulose and cellulose). In existing method, holocellulose can be prepared by a chlorination method, a sodium chlorite method, a chlorine dioxide method, and a peracetic acid method. The chlorination method uses a toxic, flammable, and explosive chlorine gas that causes potential safety hazards and produces by-products that pollute the environment. Chlorine dioxide method requires special equipment to prepare and store chlorine dioxide, resulting in a high cost. Sodium chlorite and the hydrogen peroxide-acetic acid pretreatments are the most widely used methods for preparing holocellulose from biomass material. Sodium chlorite method is conducted as follows: a 6 wt % sodium chlorite solution having a pH adjusted with acetic acid to 3.6 to 3.8 is subjected to pretreatment at 80° C. for 2 h, such that 67.7 wt % lignin of biomass material is removed. This sodium chlorite pretreated sample has a lignin content of 10.8% and includes a chlorine substituent, which is not conducive to the enzymatic hydrolysis of biomass. In addition, this method has problems with the production of toxic substances such as chlorine dioxide and a chlorine gas, and sodium chlorite used is a carcinogen. The hydrogen peroxide-acetic acid method could result in a holocellulose product with a low lignin content. However, because large amounts of hydrogen peroxide and acetic acid are used, peracetic acid produced has a strong irritating effect on eyes, skin and mucosae, and upper respiratory tracts of humans, can cause conditions such as inflammation of larynxes and bronchi after being inhaled, and is harmful to the human body. Moreover, large amounts of hydrogen peroxide and acetic acid used in hydrogen peroxide-acetic acid method result in a high reagent cost.

### SUMMARY

In view of this, an object of the present disclosure is to provide a method for preparing holocellulose. In the present disclosure, the oxidative decomposition of lignin in a biomass material can be eco-friendly and efficiently achieved to prepare high-quality holocellulose in which a mass percentage content of lignin is lower than 6%.

To achieve the above object, the present disclosure provides the following technical solutions:

The present disclosure provides a method for preparing holocellulose, including:
mixing a biomass material and a pretreatment solution, and subjecting a resulting mixture to pretreatment and solid-liquid separation in sequence to obtain the holocellulose, where a mass percentage content of lignin in the holocellulose is lower than 6%;
the pretreatment solution includes an aqueous hydrogen peroxide solution and a catalyst;
the pretreatment is conducted at a pH of 2 to 7; and
the catalyst includes one or more selected from the group consisting of tungstic acid, molybdic acid, tungsten carbide, molybdenum carbide, tungsten sulfide, molybdenum sulfide, heteropoly acid, and a heteropoly acid salt, where the heteropoly acid includes one or more selected from the group consisting of phosphotungstic acid and phosphomolybdic acid, and the heteropoly acid salt includes a phosphotungstate salt.

In some embodiments, a concentration of hydrogen peroxide in the pretreatment solution is in a range of 50 g/L to 150 g/L.

In some embodiments, a concentration of the catalyst in the pretreatment solution is in a range of 5 mmol/L to 50 mmol/L.

In some embodiments, a ratio of a dry weight of the biomass material to a mass of the pretreatment solution is in a range of 1:8 to 1:12.

In some embodiments, the pretreatment is conducted by standing and heating; and the standing and heating is conducted at 60° C. to 90° C.

In some embodiments, the standing and heating is conducted for 1 h to 3 h.

In some embodiments, the standing and heating is conducted for 10 h to 20 h; and under the condition that the standing and heating is conducted for 10 h to 20 h, the holocellulose is a nano-scale oxidized cellulose.

In some embodiments, the biomass material is a powdered material having a particle size of less than 50 mesh.

In some embodiments, the catalyst is one or more selected from the group consisting of phosphotungstic acid and sodium phosphotungstate.

In some embodiments, the holocellulose has a yield of 50% to 65%.

The present disclosure provides a method for preparing holocellulose, including: mixing a biomass material and a pretreatment solution, and subjecting a resulting mixture to pretreatment and solid-liquid separation in sequence to obtain the holocellulose, where a mass percentage content of lignin in the holocellulose is lower than 6%; the pretreatment solution includes an aqueous hydrogen peroxide solution and a catalyst; the pretreatment is conducted at a pH of 2 to 7; and the catalyst includes one or more selected from the group consisting of tungstic acid, molybdic acid, tungsten carbide, molybdenum carbide, tungsten sulfide, molybdenum sulfide, heteropoly acid, and a heteropoly acid salt, where the heteropoly acid includes one or more selected from the group consisting of phosphotungstic acid and phosphomolybdic acid, and the heteropoly acid salt includes a phosphotungstate salt. In the present disclosure, hydrogen peroxide is used to oxidize lignin, and a catalyst is used to enhance the oxidation and removal effect of hydrogen peroxide on lignin. The catalyst used in the present disclosure takes into account the two mechanisms of metal ion activation and acid catalysis to catalyze the oxidation of lignin by hydrogen peroxide. While catalyzing the decomposition of hydrogen peroxide to produce free radicals, HO⁺ can also be produced, both of which can oxidize lignin. In addition, one of degradation products of lignin is organic acid, which can react with hydrogen peroxide to form peroxycarboxylic acid. Hydrogen peroxide can also react with tungstic acid or molybdic acid to form peroxy acid. These peroxy acids can strengthen the oxidizability of this system. The heteropoly acid (phosphotungstic acid and phosphomolybdic acid) and the heteropoly acid salt (phosphotungstate salt) have strong oxidation and catalysis performance, and have a stronger catalytic effect for the oxidation of lignin by hydrogen peroxide than the ordinary tungstic acid and molybdic acid. Therefore, the oxidative decomposition of lignin in biomass material can be efficiently achieved to prepare high-quality holocellulose. In this prepared holocellulose, a mass percentage content of lignin is lower than 6% and a mass percentage content of carbohydrates is higher than 85%. The holocellulose prepared by the present disclosure has a low lignin residue rate and a high carbohydrate retention rate.

In addition, the hydrogen peroxide used in the present disclosure is an eco-friendly oxidant, which is non-toxic and harmless, easy to treat, and can be decomposed into water and oxygen after heating, which significantly reduces the pollution to the environment. In the present disclosure, the goal of efficiently preparing holocellulose (in which a mass percentage content of carbohydrates is greater than or equal to 90%) from a biomass material within 1 h can be achieved, thereby improving the production efficiency. In the method, the catalyst in the pretreatment solution has a weaker acidity than sulfuric acid, causes little corrosion to equipment, and can be recycled, reducing the requirements and maintenance costs for the equipment.

### DETAILED DESCRIPTION OF THE EMBODIMENTS

The present disclosure provides a method for preparing holocellulose, including the following step:
mixing a biomass material and a pretreatment solution, and subjecting a resulting mixture to pretreatment and solid-liquid separation to obtain the holocellulose, where a mass percentage content of lignin in the holocellulose is lower than 6%;
the pretreatment solution includes an aqueous hydrogen peroxide solution and a catalyst;
the pretreatment is conducted at a pH of 2 to 7; and
the catalyst includes one or more selected from the group consisting of tungstic acid, molybdic acid, tungsten carbide, molybdenum carbide, tungsten sulfide, molybdenum sulfide, heteropoly acid, and a heteropoly acid salt, where the heteropoly acid includes one or more selected from the group consisting of phosphotungstic acid and phosphomolybdic acid, and the heteropoly acid salt includes a phosphotungstate salt.

Unless otherwise specified, there are no special requirements for sources of the raw materials used, and commercially available products well known to those skilled in the art may be used.

In the present disclosure, a biomass material and a pretreatment solution are mixed, and a resulting mixture is subjected to pretreatment and solid-liquid separation in sequence to obtain the holocellulose.

As an embodiment, the biomass material is a biomass raw material including cellulose and lignin components; and the biomass material includes one or more selected from the group consisting of a timber and a crop straw; and in some embodiments, the biomass material is a timber, and the timber is a poplar.

As an embodiment, the biomass material is a powdered material having a particle size of less than 50 mesh.

As an embodiment, the pretreatment solution includes an aqueous hydrogen peroxide solution and a catalyst; and the catalyst includes one or more selected from the group consisting of tungstic acid, molybdic acid, tungsten carbide, molybdenum carbide, tungsten sulfide, molybdenum sulfide, heteropoly acid, and a heteropoly acid salt, and in some embodiments, is a heteropoly acid or a heteropoly acid salt.

As an embodiment, the heteropoly acid includes one or more selected from the group consisting of phosphotungstic acid and phosphomolybdic acid. In a specific embodiment, the heteropoly acid is phosphotungstic acid; and the heteropoly acid salt includes a phosphotungstate salt, and in some embodiments, is a phosphotungstate salt, and the phosphotungstate salt is sodium phosphotungstate.

As an embodiment, the pretreatment is conducted at a pH of 2 to 7, and in some embodiments, the pretreatment is conducted at a pH of 3 to 6; a concentration of the hydrogen peroxide in the pretreatment solution is in a range of 50 g/L to 150 g/L, and in some embodiments, is in a range of 50 g/L to 100 g/L; a concentration of the catalyst in the pretreatment solution is in a range of 5 mmol/L to 50 mmol/L, and in some embodiments, is in a range of 10 mmol/L to 20 mmol/L; and a ratio of a dry weight of the biomass material to a mass of the pretreatment solution is in a range of 1:8 to 1:12, and in some embodiments, is in a range of 1:9 to 1:11. Under the condition that the concentration of the catalyst in the pretreatment solution is higher than 10 mmol/L, the standing and heating is conducted for 1 h or less. Under the condition that the concentration of the catalyst is low in the pretreatment solution, the time of the standing and heating needs to be extended.

As an embodiment, in order to obtain high-purity holocellulose, a minimum concentration of the poly acid and the poly acid salt in the pretreatment solution is 5 mmol/L, and a pH of the pretreatment solution is in a range of 2 to 7, and in some embodiments, is in a range of 3 to 6.

Hydrogen peroxide is an eco-friendly oxidant that have an oxidation for lignin. The degradation products of hydrogen peroxide are pollution-free water and oxygen. The first function of the catalyst is that a special spatial structure can catalyze the oxidation of lignin by hydrogen peroxide. The second function of the catalyst is that some anions can produce peroxides to oxidize lignin. The catalytic-hydrogen peroxide system used in the present disclosure can oxidize lignin and retain carbohydrates to prepare high-purity holocellulose.

Although hydrogen peroxide is a strong oxidant, hydrogen peroxide has a very weak oxidizing ability for lignin, and allows a less than 30% lignin removal for a biomass material. In existing reports, to improve the oxidative removal of lignin by hydrogen peroxide, three methods are used, namely, alkali catalysis, acid catalysis, and metal ion activation. In the alkali catalysis, hydrogen peroxide releases hydroxyl and superoxide free radicals. The alkali catalysis method leads to incomplete lignin removal and heavy xylan loss. In an acidic hydrogen peroxide catalytic system, sulfuric acid is used as a catalyst. 50% or more of acetic acid or formic acid and phosphoric acid are used to the synthesis of peroxy acid. Peroxy acid and HO⁺ are the main causes of lignin oxidation. In a metal ion-activated system, hydrogen peroxide is activated by metal ions to produce free radicals for an advanced oxidation reaction to degrade lignin. In the metal ion activation method, most hemicellulose is removed, and the lignin removal rate is undesirability. The present disclosure takes into account the two mechanisms of metal ion activation and acidic catalysis. While catalyzing the decomposition by hydrogen peroxide by tungstic acid and molybdic acid, the both the produced free radicals and HO⁺ can oxidize lignin.

In addition, a degradation product of lignin is an organic acid, which can react with hydrogen peroxide to produce peroxycarboxylic acid. Hydrogen peroxide can also react with tungstic acid or molybdic acid to produce a peroxy acid. These peroxy acids can strengthen the oxidation performance of the system. After calculation, phosphotungstic acid is a classic heteropoly acid. Special spatial configurations such as Keggin and the phosphotungstate salt Silverton provide some heteropoly acids with strong oxidation and catalysis performance. The heteropoly acids of phosphotungstic acid and phosphomolybdic acid and the phosphotungstate salt provided by the present disclosure have a stronger catalytic effect and are more favorable to the preparation of holocellulose than the ordinary tungstic acid and molybdic acid. The present disclosure takes into account the characteristics of both acid catalysis and metal ion activation mechanisms. The method provided by the present disclosure further reduces the introduction of acetic acid and formic acid in an acid catalysis system, avoids the introduction of a large amount of a strong acid catalyst, and improves the retention effect for hemicellulose (xylan), thereby achieving the selective removal of lignin among the three major components in the biomass material to prepare high-purity holocellulose.

As an embodiment, the pretreatment is conducted under standing and heating; the standing and heating is conducted at a temperature of 60° C. to 90° C., and in some embodiments, the standing and heating is conducted at a temperature of 70° C. to 80° C.; and the standing and heating is conducted for 1 h to 3 h, and in some embodiments, the standing and heating is conducted for 1 h or 3 h.

As another embodiment, the standing and heating is conducted for 10 h to 20 h; and under the condition that the standing and heating is conducted for 10 h to 20 h, the holocellulose prepared is a nano-scale oxidized cellulose.

As another embodiment, the pretreatment is conducted in a closed reaction vessel, and in some embodiments, is conducted in a closed reactor; and a volume of a liquid filled in the reaction vessel does not exceed 50% of a volume of the reaction vessel.

As an embodiment, before the solid-liquid separation, the method further includes: cooling a mixed solution obtained after the pretreatment to room temperature, where the cooling refers to natural cooling.

As an embodiment, the solid-liquid separation is conducted by filtration or centrifugation, and in some embodiments, is conducted by filtration, and the filtration is conducted by suction filtration.

As an embodiment, a mass percentage content of carbohydrates in the holocellulose is higher than or equal to 90%, and in some embodiments, is in a range of 90% to 96%; and a mass percentage content of the lignin in the holocellulose is lower than 6%, and in some embodiments, is in a range of 1.7% to 5.9%.

As an embodiment, in the preparation method of holocellulose provided by the present disclosure, the lignin has a removal rate of 88% to 97%, and in some embodiment, has a removal rate of 90% to 95%; a yield of the holocellulose is in a range of 50% to 65%, and in some embodiments, is in a range of 55% to 60%.

While oxidizing and degrading lignin, the present disclosure retains a large amount of carbohydrate, that is, the most holocellulose component is not degraded. In the traditional sulfuric acid-catalytic hydrogen peroxide-acetic acid system (peracetic acid method), sulfuric acid is used as a catalyst. Increasing the sulfuric acid loading can increase the acidity (the solution pH is lower than 0) of pretreatment system and aggravate the loss of hemicellulose. The pretreatment solution used in the present disclosure has a pH of 2 to 7, and has a weaker acidity than the pretreatment system with the 10 mM sulfuric acid. Therefore, among the three major components of cellulose, hemicellulose, and lignin in the biomass material, only 90% or more of lignin is oxidative removed, the carbohydrate loss is less than 15%, and shows a high carbohydrate retention rate. Moreover, compared with the sodium chlorite pretreatment, the method provided by present disclosure is non-toxic and harmless, and involves a shorter reaction time and a lower lignin residue. Compared with the hydrogen peroxide-acetic acid pretreatment method, method provided by the present disclosure involves a lower hydrogen peroxide loading and without a large amount of organic acid, and leads to no gas such as peracetic acid that irritates the respiratory tract. Therefore, method provided by the present disclosure not only greatly improves the preparation efficiency and quality of holocellulose, but also has significant advantages such as low-temperature operation, environmental friendliness, and efficient output. The preparation method provided by the present disclosure is very suitable for the large-scale preparation of holocellulose and the material demand of bio-refinery, and opened up a new path for the diversified and efficient utilization of biomass resources.

The technical solutions in the present disclosure will be clearly and completely described below with reference to the examples in the present disclosure, but the examples shall not be construed as limiting the scope of the present disclosure.

### Example 1

200 mL of hydrogen peroxide (30 wt % hydrogen peroxide solution) and phosphotungstic acid were added to 800 mL of water, and stirred uniform to obtain a pretreatment solution, in which a concentration of the hydrogen peroxide was 67 g/L, and a concentration of the phosphotungstic acid was 20 mmol/L, and the pretreatment solution had a pH of 2.4. 100 g of a poplar powder (having a particle size of less than 50 mesh) and 1 L of the pretreatment solution were thoroughly mixed, a resulting mixture was then transferred to a closed reactor with a liquid volume not exceeding 50% of a volume of the reactor, subjected to standing and heating at 80° C. for 1 h, and naturally cooled to room temperature, and a resulting material was filtered to produce a residue, which was holocellulose.

### Example 2

This example was the same as Example 1, except that the phosphotungstic acid in Example 1 was replaced with sodium phosphotungstate.

### Example 3

This example was the same as Example 1, except that the concentration of the phosphotungstic acid in the pretreatment solution was 10 mmol/L and the standing and heating was conducted for 3 h.

### Example 4

This example was the same as Example 2, except that the concentration of the sodium phosphotungstate in the pretreatment solution was 10 mmol/L and the standing and heating was conducted for 3 h.

### Example 5

This example was the same as Example 1, except that the standing and heating was conducted at 90° C.

### Example 6

This example was the same as Example 1, except that the standing and heating was conducted at 70° C.

### Example 7

This example was the same as Example 1, except that the phosphotungstic acid in Example 1 was replaced with phosphomolybdic acid.

### Example 8

This example was the same as Example 3, except that the phosphotungstic acid in Example 3 was replaced with molybdic acid and a concentration of the molybdic acid in the pretreatment solution was 50 mmol/L.

### Example 9

This example was the same as Example 3, except that the phosphotungstic acid in Example 3 was replaced with tungstic acid and a concentration of the tungstic acid in the pretreatment solution was 50 mmol/L.

### Example 10

This example was the same as Example 3, except that the phosphotungstic acid in Example 3 was replaced with tungsten carbide and a concentration of the tungsten carbide in the pretreatment solution was 50 mmol/L.

### Example 11

This example was the same as Example 3, except that the phosphotungstic acid in Example 3 was replaced with molybdenum carbide and a concentration of the molybdenum carbide in the pretreatment solution was 50 mmol/L.

### Example 12

This example was the same as Example 3, except that the phosphotungstic acid in Example 3 was replaced with tungsten sulfide and a concentration of the tungsten sulfide in the pretreatment solution was 50 mmol/L.

### Example 13

This example was the same as Example 3, except that the phosphotungstic acid in Example 3 was replaced with molybdenum sulfide and a concentration of the molybdenum sulfide in the pretreatment solution was 50 mmol/L.

### Comparative Example 1

200 mL of hydrogen peroxide (30 wt % hydrogen peroxide solution) was added to 800 mL of water, and stirred uniform to obtain an aqueous hydrogen peroxide solution. 100 g of a poplar powder (having a particle size of less than 50 mesh) and the aqueous hydrogen peroxide solution were thoroughly mixed, a resulting mixture was then transferred to a closed reactor with a liquid volume not exceeding 50% of a volume of the reactor, subjected to standing and heating at 80° C. for 1 h, and naturally cooled to room temperature, and a resulting material was filtered to produce a residue with a lignin content of more than 25%, which could not be called holocellulose.

### Comparative Example 2

This example was the same as Example 3, except that the phosphotungstic acid in Example 3 was replaced with silicotungstic acid and a concentration of the silicotungstic acid in the pretreatment solution was 20 mmol/L.

### Comparative Example 3

This example was the same as Example 3, except that the phosphotungstic acid in Example 3 was replaced with sodium tungstate and a concentration of the sodium tungstate in the pretreatment solution was 50 mmol/L.

### Comparative Example 4

This example was the same as Example 3, except that the phosphotungstic acid in Example 3 was replaced with sodium phosphomolybdate and a concentration of the sodium phosphomolybdate in the pretreatment solution was 20 mmol/L.

### Performance Testing

The holocellulose samples prepared in Examples 1 to 13 and the samples prepared in Comparative Examples 1 to 4 each were tested for a yield of the holocellulose and a removal rate of lignin, and the results are shown in Table 1.

A lignin content was calculated according to the method of the National Renewable Energy Laboratory:

$$Lignin content ( \% ) = \frac{Mass of residual lignin after pretreatment}{Mass of raw material after pretreatment} \times 100 and$$

$$Holocellulose yield ( \% ) = \frac{Mass of residue after pretreatment}{Mass of raw material before pretreatment} \times 100.$$

TABLE 1
Properties of holocellulose samples prepared in Examples 1
to 13 and products prepared in Comparative Examples 1 to 4

| | Lignin | Carbohydrate | Lignin mass | |
|---|---|---|---|---|
| Serial | removal | retention | percentage | Holocellulose |
| Number | rate/% | rate/% | content/% | yield/% |
| Example 1 | 95 | 92 | 2.8 | 55 |
| Example 2 | 94 | 93 | 3.3 | 57 |
| Example 3 | 91 | 90 | 1.7 | 54 |
| Example 4 | 90 | 94 | 4.7 | 60 |
| Example 5 | 97 | 90 | 1.9 | 50 |
| Example 6 | 88 | 95 | 5.9 | 63 |
| Example 7 | 93 | 94 | 3.7 | 58 |
| Example 8 | 88 | 96 | 5.7 | 65 |
| Example 9 | 94 | 92 | 3.4 | 55 |
| Example 10 | 95 | 90 | 3.0 | 52 |
| Example 11 | 90 | 92 | 5.7 | 54 |
| Example 12 | 96 | 90 | 2.5 | 50 |
| Example 13 | 90 | 92 | 4.7 | 53 |
| Comparative | 45 | 96 | 26 | No holocellulose |
| Example 1 | | | | was obtained |
| Comparative | 60 | 94 | 25 | No holocellulose |
| Example 2 | | | | was obtained |
| Comparative | 60 | 93 | 23 | No holocellulose |
| Example 3 | | | | was obtained |
| Comparative | 63 | 92 | 21 | No holocellulose |
| Example 4 | | | | was obtained |

It can be seen from Table 1 that the method for preparing holocellulose provided by the present disclosure has a lignin removal rate of 88% to 97% and a holocellulose yield of 50% to 65%. However, in Comparative Example 1, the method in which only using an aqueous hydrogen peroxide solution without a catalyst has a lignin removal rate of 45%, and lignin mass percentage content are more than 25%, and no holocellulose is obtained. In the solutions in which silicotungstic acid, sodium tungstate, and sodium phosphomolybdate are used as catalysts in Comparative Examples 2, 3, and 4, respectively, the samples prepared all have a lignin content of higher than 20%, and thus cannot be called holocellulose. Therefore, high-quality holocellulose can be efficiently prepared by the present disclosure.

Although the present disclosure has been described in detail through the above embodiments, the embodiments are merely some rather than all of the embodiments of the present disclosure. Other embodiments can be acquired by a person based on these embodiments without creative efforts, and these embodiments shall fall within the scope of the present disclosure.

What is claimed is:

1. A method for preparing holocellulose, comprising:
mixing a biomass material and a pretreatment solution, and subjecting a resulting mixture to pretreatment and solid-liquid separation in sequence to obtain the holocellulose, wherein
a mass percentage content of lignin in the holocellulose is lower than 6%;
the pretreatment solution comprises an aqueous hydrogen peroxide solution and a catalyst;
the pretreatment is conducted at a pH of 2 to 7; and
the catalyst comprises one or more selected from the group consisting of tungstic acid, molybdic acid, tungsten carbide, molybdenum carbide, tungsten sulfide, molybdenum sulfide, heteropoly acid, and a heteropoly acid salt, wherein the heteropoly acid comprises one or more selected from the group consisting of phosphotungstic acid and phosphomolybdic acid, and the heteropoly acid salt comprises a phosphotungstate salt.

2. The method of claim 1, wherein a concentration of hydrogen peroxide in the pretreatment solution is in a range of 50 g/L (gram/Liter) to 150 g/L.

3. The method of claim 1, wherein a concentration of the catalyst in the pretreatment solution is in a range of 5 mmol/L (millimole/Liter) to 50 mmol/L.

4. The method of claim 1, wherein a ratio of a dry weight of the biomass material to a mass of the pretreatment solution is in a range of 1:8 to 1:12.

5. The method of claim 1, wherein the pretreatment is conducted by standing and heating; and the standing and heating is conducted at 60° C. to 90° C.

6. The method of claim 5, wherein the standing and heating is conducted for 1 hour to 3 hours.

7. The method of claim 5, wherein the standing and heating is conducted for 10 hours to 20 hours; and under the condition that the standing and heating is conducted for 10 hours to 20 hours, the holocellulose is a nano-scale oxidized cellulose.

8. The method of claim 1, wherein the biomass material is a powdered material having a particle size of less than 50 mesh.

9. The method of claim 1, wherein the catalyst is one or more selected from the group consisting of phosphotungstic acid and sodium phosphotungstate.

10. The method of claim 1, wherein the holocellulose has a yield of 50% to 65%.

11. The method of claim 2, wherein a ratio of a dry weight of the biomass material to a mass of the pretreatment solution is in a range of 1:8 to 1:12.

12. The method of claim 3, wherein a ratio of a dry weight of the biomass material to a mass of the pretreatment solution is in a range of 1:8 to 1:12.
